(19) United States
(12) Patent Application Publication
(10) Pub. No.: US 2008/0317983 A1
(43) Pub. Date: Dec. 25, 2008

(54) Paperboard with bio-degradable surface layer

(76) Inventor: Hsi-Ching Chang, Taichung (TW)

Correspondence Address: Hsi-Ching Chang, P.O. BOX 215, TAICHUNG, 40099, TW

(21) Appl. No.: 11/892,312

(22) Filed: Aug. 22, 2007

(30) Foreign Application Priority Data
Jun. 25, 2007 (TW) 096122955

(51) Int. Cl. B32B 1/02

(52) U.S. Cl. 428/34.2

(57) ABSTRACT

A paperboard assembly for food box includes a piece of paperboard and a layer of cross linker is attached to at least one of inner surface and outer surface of the paperboard. At least one bio-degradable surface layer is attached to the layer of cross linker by way of heat-and-press. The At least one bio-degradable surface layer is made by way of supercritical CO₂ Microcellular Foaming in Extrusion Process.

### FIELD OF THE INVENTION

The present invention relates to a paperboard with a bio-degradable surface layer which is made by way of supercritical CO₂ Microcellular Foaming in Extrusion Process.

### BACKGROUND OF THE INVENTION

A conventional food box made with paperboard generally includes a heat isolation layer which avoids heat of the food from escaping and the heat isolation layer is attached to the outer surface of the food box and usually made by Polylactic Acid (PLA), Polycaprolactone (PCL) and Aliphatic Compound. However, due to chemical restriction and method for making the food box, the heat isolation layer is attached to the food box after the food box is made. In other words, the food box for example, includes four sidewalls, a bottom and an open top, the heat isolation layer is then spread on the outer surface of the food box. The food box and the heat isolation layer are then heated to let the heat isolation layer to be foam status and attached to the food box. The thickness of the heat isolation layer on the food box is difficult to be controlled.

The present invention intends to provide a paperboard with a bio-degradable surface layer which is made by way of supercritical CO₂ Microcellular Foaming in Extrusion Process. The bio-degradable surface layer is attached to the paperboard by way of heat-and-press. The thickness of the bio-degradable surface layer can be easily controlled.

### SUMMARY OF THE INVENTION

The present invention relates to a paperboard assembly for food box and includes a piece of paperboard with a layer of cross linker is attached to the inner surface and/or the outer surface of the paperboard. At least one bio-degradable surface layer is attached to the layer of cross linker by way of heat-and-press. The At least one biodegradable surface layer is made by way of supercritical CO₂ Microcellular Foaming in Extrusion Process.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a cross sectional view to show the paperboard and the bio-degradable surface layer of the present invention;

FIG. 2 is a cross sectional view to show another embodiment of the present invention, wherein a layer of cross linker is located between the paperboard and the biodegradable surface layer of the present invention, and

FIG. 3 is a cup made by the paperboard with the bio-degradable surface layer of the present invention.

### DETAILED DESCRIPTION OF THE PREFERRED EMBODIMENT

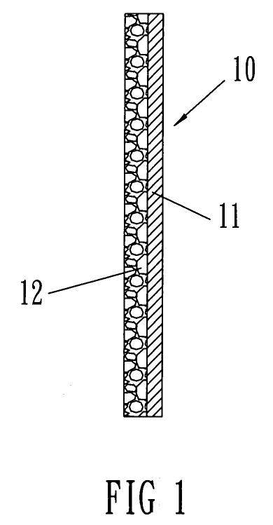

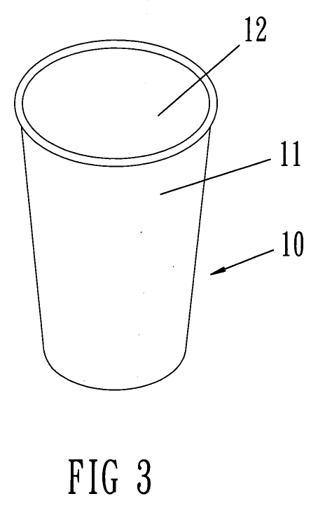

Referring to FIG. 1, the paperboard assembly 10 for food box of the present invention comprises a piece of paperboard 11 and at least one bio-degradable surface layer 12 is attached to at least one of inner surface and outer surface of the paperboard 11. The at least one bio-degradable surface layer 12 is made by way of supercritical CO₂ Microcellular Foaming in Extrusion Process. The at least one bio-degradable surface layer 12 is a foam layer of Polylactic Acid (PLA). The at least one bio-degradable surface layer 12 includes high density of pores and the diameter of the pores is small so that the appearance of the outer surface of the at least one biodegradable surface layer 12 is smooth. The at least one bio-degradable surface layer 12 is attached to the paperboard 11 before the paperboard 11 is processed to be a certain shape so that the thickness of the at least one bio-degradable surface layer 12 can be conveniently controlled. The paperboard 11 with the bio-degradable surface layer 12 can then be cut and folded to desired shape such as a cup shown in FIG. 3.

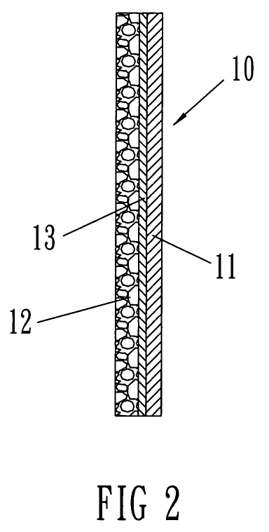

FIG. 2 shows another embodiment of the present invention and comprises a piece of paperboard 11 and a layer of cross linker 13 is attached to the inner surface and/or the outer surface of the paperboard 11. At least one bio-degradable surface layer 12 is attached to the layer of cross linker 13 and made by way of supercritical CO₂ Microcellular Foaming in Extrusion Process.

The layer of cross linker 13 is made by bio-degradable material which is FEG Eco-Polymer which has high melting point and flexible so that when bending the food box, the layer of cross linker 13 can be bent or machined without cracking.

While we have shown and described the embodiment in accordance with the present invention, it should be clear to those skilled in the art that further embodiments may be made without departing from the scope of the present invention.

What is claimed is:

1. A paperboard assembly for food box, comprising:
a piece of paperboard and at least one bio-degradable surface layer attached to at least one of inner surface and outer surface of the paperboard, the at least one bio-degradable surface layer being made by way of supercritical CO₂ Microcellular Foaming in Extrusion Process.

2. The paperboard assembly for food box as claimed in claim 1, wherein the at least one bio-degradable surface layer is a foam layer of Polylactic Acid (PLA).

3. A paperboard assembly for food box, comprising:
a piece of paperboard and a layer of cross linker attached to at least one of inner surface and outer surface of the paperboard, at least one bio-degradable surface layer attached to the layer of cross linker and being made by way of supercritical CO₂ Microcellular Foaming in Extrusion Process.

4. The paperboard assembly for food box as claimed in claim 3, wherein the layer of cross linker is made by bio-degradable material which is FEG Eco-Polymer.

5. The paperboard assembly for food box as claimed in claim 3, wherein the at least one bio-degradable surface layer is a foam layer of Polylactic Acid (PLA).
